(19) United States
(12) Patent Application Publication
(10) Pub. No.: US 2026/0279973 A1
(43) Pub. Date: Sep. 17, 2026

(54) METAL-AIR BATTERY, POWER SUPPLY INCLUDING THE SAME, AND METHOD OF MANUFACTURING METAL-AIR BATTERY

(71) Applicant: Samsung Electronics Co., Ltd., Suwon-si (KR)

(72) Inventors: Heungchan Lee, Suwon-si (KR); Mokwon Kim, Suwon-si (KR); Taeyoung Kim, Suwon-si (KR); Jungock Park, Suwon-si (KR); Jaeho Shin, Suwon-si (KR)

(21) Appl. No.: 19/457,367

(22) Filed: Jan. 23, 2026

(30) Foreign Application Priority Data
Feb. 5, 2025 (KR) 10-2025-0014710

(51) Int. Cl. H01M 12/06; H01M 4/02; H01M 4/38

(52) U.S. Cl. CPC H01M 12/06; H01M 4/38; H01M 2004/027

(57) ABSTRACT

Provided are a metal-air battery, a power supply including the same, and a method of manufacturing a metal-air battery, wherein the metal-air battery includes a cathode configured to use oxygen as an active material, an anode including an anode current collector and an aluminum metal extending in a first direction from a first end adjacent to the anode current collector to a second end opposite the first end, and an electrolyte between the cathode and the anode, wherein a distance between the cathode and the aluminum metal decreases in the first direction.

### CROSS-REFERENCE TO RELATED APPLICATION

This application claims priority to and the benefit of Korean Patent Application No. 10-2025-0014710, filed on Feb. 5, 2025, in the Korean Intellectual Property Office, and all the benefits accruing therefrom under 35 U.S.C. § 119, the content of which in its entirety is herein incorporated by reference.

### BACKGROUND

### 1. Field

The disclosure relates to a metal-air battery, a power supply including the same, and a method of manufacturing a metal-air battery.

### 2. Description of the Related Art

A metal-air battery includes an anode capable of dissolving metal ions during discharge, a cathode that reduces oxygen in air, and an electrolyte interposed between the cathode and the anode.

Metal-air batteries use a metal itself as an anode, and air, which is a cathode active material, does not need to be stored in the batteries, such that high-capacity batteries are possible.

Among metal-air batteries, aluminum-air batteries have a very high theoretical energy density per unit weight of greater than or equal to 8,100 watt-hours per liter (Wh/L).

### SUMMARY

The actual discharge capacity of a metal-air battery is less than or equal to 50% of the theoretical discharge capacity. The actual discharge capacity of a metal-air battery may be reduced by side reactions such as a galvanic reaction or the like that generate hydrogen, heat loss due to, for example, an overvoltage, non-uniform electrode reactions, and the like. Non-uniform electrode reactions occur due to, for example, non-uniformity in electrode composition and non-uniformity in current density. When a metal-air battery including a metal anode is discharged, a relatively high current density may occur in an area adjacent to an anode current collector, and dissolution of the metal anode may be concentrated in the area adjacent to the anode current collector. As a metal anode is dissolved in an area adjacent to an anode current collector, the metal anode may be disconnected in an area adjacent to a current collector, and a sharp drop in the capacity of the metal anode may occur. Desired is a method capable of preventing non-uniform electrode reactions and preventing the disconnection of a metal anode.

Provided is a metal-air battery having a novel structural which may prevent the disconnection of a metal anode in an area adjacent to an anode current collector during discharge.

Provided is a power supply including the metal-air battery.

Provided is a method of manufacturing the metal-air battery.

Additional aspects will be set forth in part in the description which follows and, in part, will be apparent from the description, or may be learned by practice of the presented embodiments of the disclosure.

According to an embodiment of the disclosure, a metal-air battery includes a cathode configured to use oxygen as an active material, an anode including an anode current collector and an aluminum metal extending in a first direction from a first end adjacent to the anode current collector to a second end opposite the first end, and
an electrolyte between the cathode and the anode,
wherein a distance between the cathode and the aluminum metal decreases in the first direction.

According to an embodiment of the disclosure,
a power supply includes the metal-air battery,
an inverter configured to convert direct current power output from the metal-air battery into alternating current power, and
an output unit configured to output, to a load, the alternating current power converted by the inverter.

According to an embodiment of the disclosure,
a method of manufacturing a metal-air battery includes providing a cathode configured to use oxygen as an active material,
providing an anode including an anode current collector and an aluminum metal extending in a first direction from a first end adjacent to the anode current collector to a second end opposite the first end, and
providing an electrolyte between the cathode and the anode,
wherein a distance between the cathode and the aluminum metal decreases in the first direction.

According to an embodiment of the disclosure,
a method of operating a metal-air battery including a cathode configured to use oxygen as an active material, an aluminum metal anode including an anode current collector and an extending in a first direction from a first end adjacent to the anode current collector to a second end opposite the first end, and an electrolyte between the cathode and the anode, includes
charging the aluminum-metal battery; and
discharging the aluminum-metal battery,
wherein after discharging the aluminum-metal battery, a thickness of the aluminum metal anode decreases with increasing distance from the first end aluminum metal anode to the to the second end of the aluminum metal anode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of a metal-air battery according to an embodiment;

FIG. 2 is a cross-sectional view of a metal-air battery according to an embodiment;

FIG. 3 is a cross-sectional view of a metal-air battery according to an embodiment;

FIG. 4 is a cross-sectional view of a metal-air battery according to an embodiment;

FIG. 5 is a cross-sectional view of a metal-air battery according to an embodiment;

FIG. 6 is a perspective view of a metal-air battery according to an embodiment;

FIG. 7 is a perspective view of a metal-air battery according to an embodiment;

FIG. 8 is a perspective view of a metal-air battery according to an embodiment;

FIG. 9 is a perspective view of a metal-air battery according to an embodiment;

FIG. 10 is a perspective view of a metal-air battery according to an embodiment;

FIG. 11 is a perspective view of a metal-air battery according to an embodiment;

FIG. 12 is a schematic view of a power supply according to an embodiment;

FIG. 13 is a cross-sectional view of a metal-air battery according to a related art;

FIG. 14 is a schematic view of a unit structure used for modeling a metal-air battery of Comparative Example 1 having a structure of FIG. 13;

FIG. 15 is a schematic view of a unit structure used for modeling a metal-air battery of Example 1 having a structure of FIG. 1;

FIG. 16 shows calculation results showing a thickness change of an anode at an initial state of discharging and a final stage of discharging of the metal-air battery of Comparative Example 1;

FIG. 17 shows calculation results showing a thickness change of an anode at an initial state of discharging and a final stage of discharging of the metal-air battery of Example 1; and

FIG. 18 is a graph showing a comparison between thickness changes of the metal-air batteries of Example 1 and Comparative Example 1 according to a separation distance from an anode current collector after discharging.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the FIGS., to explain aspects. As used herein, the term “and/or” includes any and all combinations of one or more of the associated listed items. Expressions such as “at least one of,” when preceding a list of elements, modify the entire list of elements and do not modify the individual elements of the list.

Various implementations are illustrated in the accompanying drawings. The present inventive concept may, however, be embodied in different forms and should not be construed as limited to the embodiments set forth herein. Rather, these embodiments are provided so that the disclosure will be thorough and complete, and will fully convey the scope of the present inventive concept to those skilled in the art. Like reference numerals designate like elements.

When it is described that an element is “on” another element, it will be understood that the element may be disposed directly on another element or still another element may be interposed therebetween. On the other hand, when it is described that an element is “directly on” another element, still another element is not interposed therebetween.

It will be understood that, although the terms “first,” “second,” and “third” may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section described below may be termed a second element, component, region, layer, or section without departing from the teachings of the present specification.

The term used herein is intended to describe only a specific embodiment and is not intended to limit the present inventive concept. As used herein, the singular forms “a,” “an,” and “the” are intended to include the plural forms, including “at least one,” unless the content clearly indicates otherwise. Thus, reference to “an” element in a claim followed by reference to “the” element is inclusive of one element and a plurality of the elements. “At least one” should not be construed as being limited to the singular. As used herein, the term “and/or” includes any and all combinations of one or more of the associated listed items. The terms “includes,” “including,” “comprises,” and/or “comprising,” when used in the detailed description, specify a presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third,” etc. may be used herein to describe various elements, components, regions, layers, and/or sections, these elements, components, regions, layers and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

Spatially relative terms such as “beneath,” “below,” “lower,” “above,” and “upper” may be used herein to easily describe one element or feature's relationship to another element or feature. It will be understood that the spatially relative terms are intended to encompass different orientations of a device in use or operation in addition to the orientation illustrated in the drawings. For example, when a device in the drawings is turned over, elements described as “below” or “beneath” other elements or features would then be “above” or “over” the other elements or features. Thus, the example term “below” may encompass both orientations of above and below. The device may be otherwise oriented (rotated 90 degrees or at other orientations), and the spatially relative terms used herein may be interpreted accordingly. “About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, ±20%, ±10% or ±5% of the stated value.

Unless otherwise defined, all terms (including technical and scientific terms) used herein have the same meaning as commonly understood by one of ordinary skill in the art to which the disclosure belongs. In addition, it will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross-sectional views which are schematic diagrams of idealized embodiments. As such, variations from the shapes of the illustrations as a result, for example, of manufacturing techniques and/or tolerances, are to be expected. Thus, the embodiments described herein should not be construed as limited to the particular shapes regions of illustrated herein but may include deviations in shapes that result, for example, from manufacturing. For example, regions illustrated or described as being flat may be typically rough and/or have nonlinear features. Moreover, sharp-drawn angles may be round. Thus, regions illustrated in the drawings are schematic in nature and their shapes are not intended to illustrate the actual shape of a region and are not intended to limit the scope of the claims.

As used herein, the term “metal” includes all of metals and metalloids such as silicon and germanium in an elemental or ionic state.

As used herein, the term “cathode active material” refers to a cathode material including oxygen and oxygen-containing gas.

As used herein, the term “anode active material” refers to an anode material capable of undergoing aluminization and dealumination.

As used herein, the terms “aluminization” and “aluminizing” refer to a process of adding aluminum to an electrode active material.

As used herein, the terms “dealumination” and “dealumination” refer to a process of removing aluminum from an electrode active material.

As used herein, the terms “charge” and “charging” refer to a process of providing electrochemical energy to a battery.

As used herein, the terms “discharge” and “discharging” refer to a process of removing electrochemical energy from a battery.

As used herein, the terms “positive electrode,” “cathode,” and “air electrode” refer to an electrode at which electrochemical reduction occurs during a discharge process.

As used herein, the terms “negative electrode” and “anode” refer to an electrode at which electrochemical oxidation and dealumination occur during a discharge process.

As used herein, the term “air” is not limited to atmospheric air and may include a combination of gases including oxygen or a pure oxygen gas. The broad definition of the term “air” may be applied to all applications, for example, air cells and air electrodes.

As used herein, the phrase “surfaces having an inclination” refers to surfaces that are neither parallel nor perpendicular to one another. Further, the term “inclination” may refer to an angle between the surfaces, e.g., the angle of the surfaces relative to or with respect to one another.

While specific embodiments have been described, alternatives, modifications, variations, improvements, and substantial equivalents that are or may be presently unforeseen may arise to applicants or others skilled in the art. Therefore, the appended claims as filed and as they may be amended are intended to embrace all such alternatives, modifications, variations, improvements, and substantial equivalents.

Hereinafter, a metal-air battery, a power supply including the same, and a method of manufacturing a metal-air battery according to an embodiment will be described in more detail.

### Metal-Air Battery

A metal-air battery according to an embodiment may include a cathode configured to use oxygen as a cathode active material, an anode including an anode current collector and an aluminum metal extending from a first end adjacent the anode current collector to a second end opposite the first end, and an electrolyte between the cathode and the anode. A facing distance between the cathode and the aluminum metal may decrease in a direction in which the aluminum metal extends from the first end to the second end.

The facing distance between the cathode and the aluminum metal decreases in the direction in which the aluminum metal extends from the first end to the second end, and oxidation of the aluminum metal may preferentially proceed in an area adjacent to the second end of the aluminum metal. The disconnection between a current collector and the aluminum metal, which may occur due to, for example, oxidation of the aluminum metal preferentially proceeding in an area adjacent to an end, e.g., the second end, of the aluminum metal during discharge of the metal-air battery, may be prevented. A rapid decrease in discharge capacity due to, for example, the disconnection of an aluminum metal anode during a discharging process of a metal-air battery may be prevented. A decrease in energy density of the metal-air battery may be prevented.

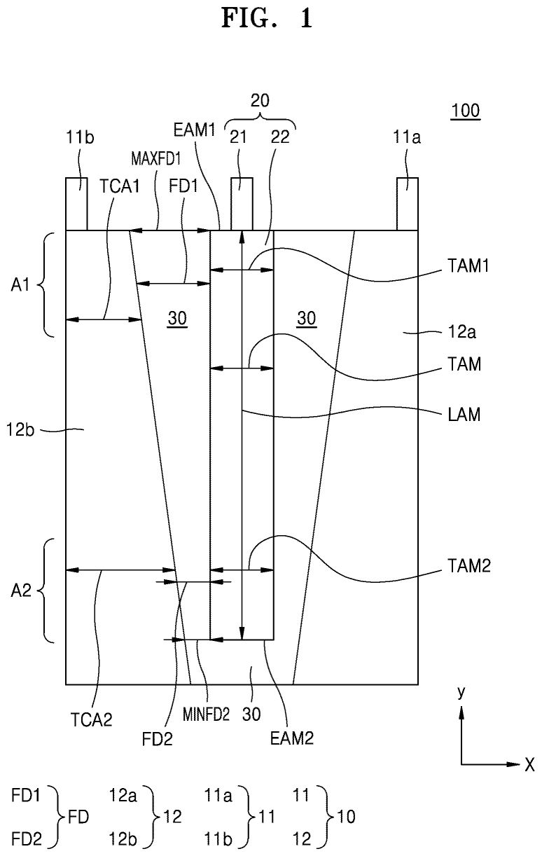

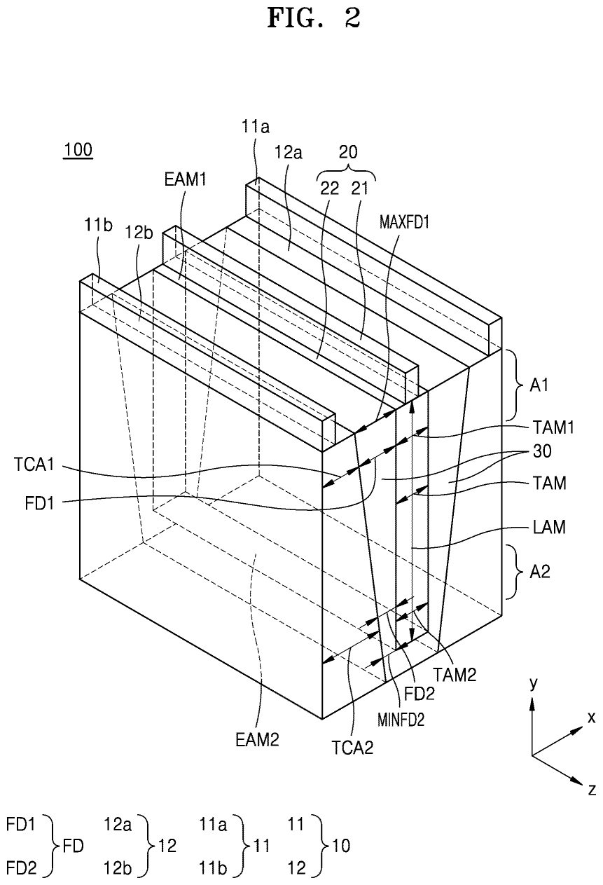

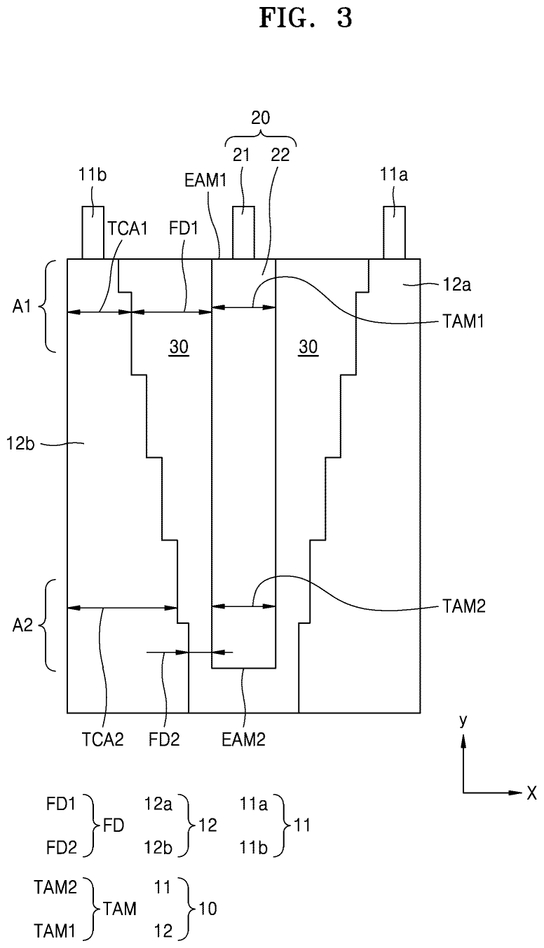

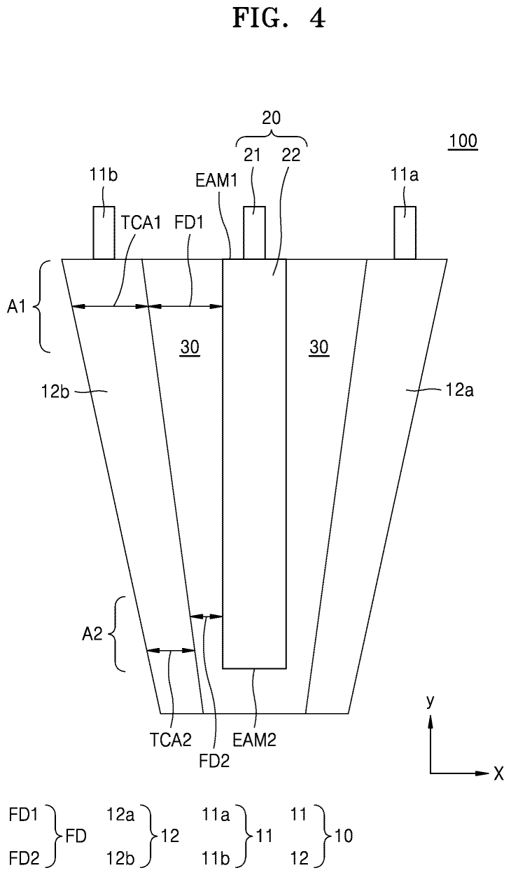

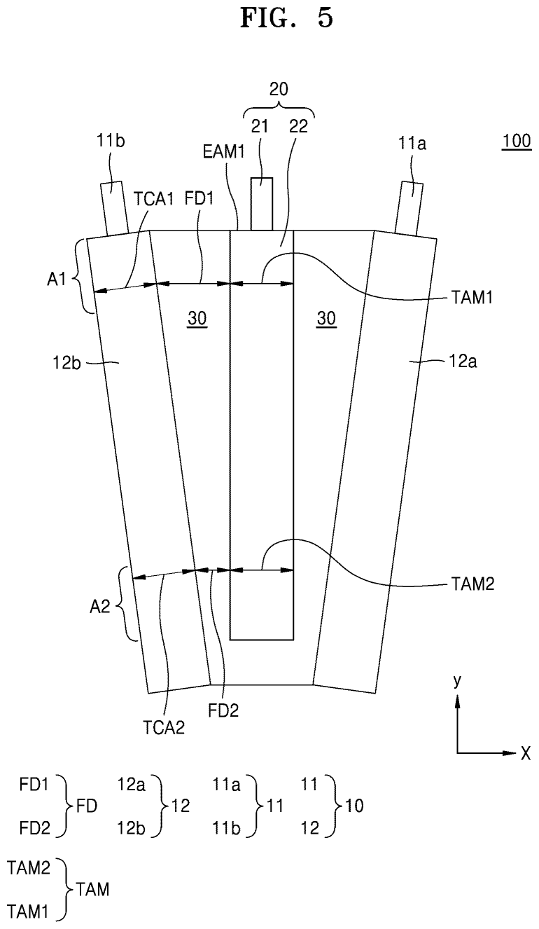

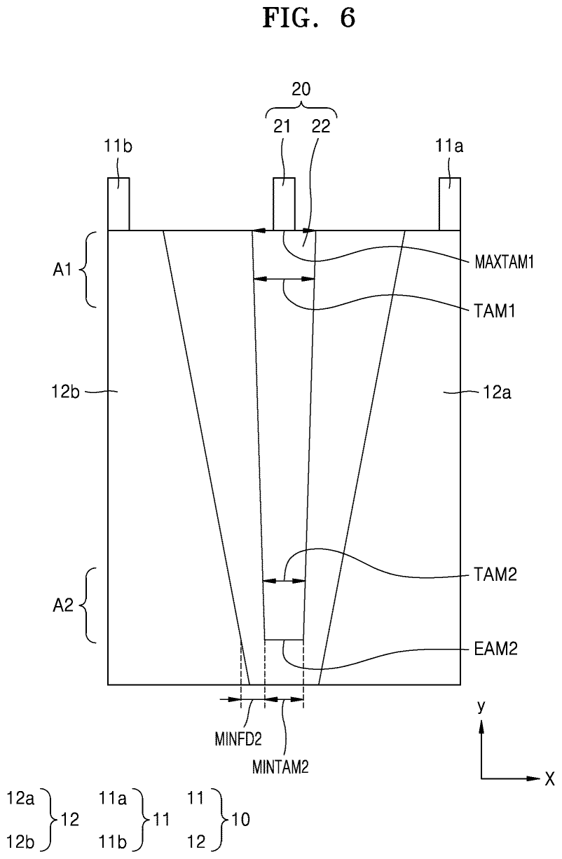

FIG. 1 is a cross-sectional view of a metal-air battery 100 according to an embodiment. FIG. 2 is a perspective view of a metal-air battery 100 according to an embodiment. FIG. 3 is a cross-sectional view of a metal-air battery 100 according to an embodiment. FIG. 4 is a cross-sectional view of a metal-air battery 100 according to an embodiment. FIG. 5 is a cross-sectional view of a metal-air battery 100 according to an embodiment. FIG. 6 is a cross-sectional view of a metal-air battery 100 according to an embodiment.

Referring to FIGS. 1 to 6, the metal-air battery 100 may include a cathode 10 configured to use oxygen as a cathode active material. Oxygen may be supplied in the form of oxygen gas or in the form of air. During discharge, oxygen may react with, for example, water to be reduced to hydroxide ions. A voltage of an oxygen reduction reaction is about 0.4 volts (V) with respect to a standard hydrogen electrode (SHE).

An anode 20 may include an anode current collector 21 and an aluminum metal 22 extending in a first direction (e.g., −y direction) from a first end EAM1 adjacent to the anode current collector 21 to a second end EAM2 opposite the first end EAM1. The anode current collector 21 may be disposed at the first end EAM1 of the aluminum metal 22, for example, on a first side of the aluminum metal 22. The aluminum metal 22 may extend in the first direction (e.g., −y direction) from the first end EAM1, for example, the first side, which is in contact with the anode current collector 21, to the second end EAM2, for example, a second side, opposite the first end EAM1. A distance between the first end EAM1 of the aluminum metal 22 and the anode current collector 21 may be shorter than a distance between the second end EAM2 of the aluminum metal 22 and the anode current collector 21.

An electrolyte 30 may be disposed between the cathode 10 and the anode 20. The electrolyte 30 may be, for example, a liquid electrolyte.

In the first direction (e.g., −y direction) in which the aluminum metal 22 extends from the first end EAM1 to the second end EAM2, that is, according to a separation distance from the anode current collector 21, a facing distance FD between the cathode 10 and the aluminum metal 22 may decrease. When the facing distance FD between the cathode 10 and the aluminum metal 22 decreases in the first direction (e.g., −y direction) in which the aluminum metal 22 extends from the first end EAM1 to the second end EAM2, preferential oxidation of the aluminum metal 22 may be induced in an area adjacent to the second end EAM2 of the aluminum metal 22.

Referring to FIGS. 1 and 2, the facing distance FD between the cathode 10 and the aluminum metal 22 may decrease continuously in the first direction (e.g., −y direction) in which the aluminum metal 22 extends. When the facing distance FD between the cathode 10 and the aluminum metal 22 decreases continuously in the direction in which the aluminum metal 22 decreases, a gradual thickness change of the aluminum metal 22 may be induced by oxidation of the aluminum metal 22 during a discharging process.

Referring to FIG. 3, the facing distance FD between the cathode 10 and the aluminum metal 22 may decrease stepwise in the first direction (e.g., −y direction) in which the aluminum metal 22 decreases. When the facing distance FD between the cathode 10 and the aluminum metal 22 decreases stepwise in the direction in which the aluminum metal 22 decreases, an area in which oxidation of the aluminum metal 22 is concentrated during a discharging process may be more easily adjusted.

Referring to FIGS. 1 to 6, the cathode 10 and the aluminum metal 22 may have a first facing distance FD1 in a first area A1 adjacent to the first end EAM1 of the aluminum metal 22. The cathode 10 and the aluminum metal 22 may have a second facing distance FD2 in a second area A2 adjacent to the second end EAM2 of the aluminum metal 22. The first facing distance FD1 may be greater than the second facing distance FD2. When the first facing distance FD1 is greater than the second facing distance FD2, oxidation of the aluminum metal 22 may be preferentially induced in the second area A2.

A ratio FD1: FD2 of the first facing distance FD1 to the second facing distance FD2 may be, for example, greater than 1:1, greater than or equal to 2:1, greater than or equal to 5:1, or greater than or equal to 10:1. The ratio FD1:FD2 of the first facing distance FD1 to the second facing distance FD2 may be, for example, greater than or equal to 100:1, greater than or equal to 80:1, less than or equal to 50:1, or less than or equal to 30:1. The ratio FD1:FD2 of the first facing distance FD1 to the second facing distance FD2 may be, for example, in a range of greater than about 1:1 to about 100:1, about 2:1 to about 8:10, about 5:1 to about 50:1, or about 10:1 to about 30:1. Since the ratio FD1: FD2 of the first facing distance FD1 to the second facing distance FD2 is within the disclosed range, oxidation of the aluminum metal 22 may be preferentially induced in the second area A2.

Referring to FIGS. 1 to 6, a ratio MAXFD1:MINFD2 of the maximum value MAXFD1 of the first facing distance to the minimum value MINFD2 of the second facing distance may be, for example, greater than or equal to 2:1, greater than or equal to 5:1, or greater than or equal to 10:1. The ratio MAXFD1:MINFD2 of the maximum value MAXFD1 of the first facing distance to the minimum value MINFD2 of the second facing distance may be, for example, less than or equal to 100:1, less than or equal to 70:1, less than or equal to 50:1, or less than or equal to 30:1. The ratio MAXFD1:MINFD2 of the maximum value MAXFD1 of the first facing distance to the minimum value MINFD2 of the second facing distance may be, for example, in a range of about 2:1 to about 100:1, about 5:1 to about 70:1, about 10:1 to about 50:1, or about 10:1 to about 30:1. When the ratio MAXFD1:MINFD2 of the maximum value MAXFD1 of the first facing distance to the minimum value MINFD2 of the second facing distance is within the disclosed range, oxidation of the aluminum metal 22 may be preferentially induced in the second area A2.

Referring to FIGS. 1 to 6, the minimum value MINFD2 of the second facing distance between the cathode 10 and the aluminum metal 22 may be less than, for example, a thickness TAM of the aluminum metal 22. When the minimum value MINFD2 of the second facing distance between the cathode 10 and the aluminum metal 22 is less than, for example, the thickness TAM of the aluminum metal 22, the energy density of the metal-air battery 100 may be improved. A ratio MINFD2: TAM of the minimum value MINFD2 of the second facing distance between the cathode 10 and the aluminum metal 22 to the thickness TAM of the aluminum metal 22 may be, for example, less than or equal to 0.9:1, less than or equal to 0.7:1, less than or equal to 0.5:1, less than or equal to 0.3:1, or less than or equal to 0.1:1. The ratio MINFD2: TAM of the minimum value MINFD2 of the second facing distance between the cathode 10 and the aluminum metal 22 to the thickness TAM of the aluminum metal 22 may be, for example, greater than or equal to 0.001:1 or greater than or equal to 0.01:1. When the ratio MINFD2: TAM of the minimum value MINFD2 of the second facing distance between the cathode 10 and the aluminum metal 22 to the thickness TAM of the aluminum metal 22 is within the disclosed range, the energy density of the metal-air battery 100 may be further improved.

Referring to FIGS. 1 to 6, the maximum value MAXFD1 of the first facing distance between the cathode 10 and the aluminum metal 22 may be greater than the thickness TAM of the aluminum metal 22. When the maximum value MAXFD1 of the first facing distance between the cathode 10 and the aluminum metal 22 is greater than the thickness TAM of the aluminum metal 22, preferential oxidation of the aluminum metal 22 in the first area A1 may be prevented. A ratio MAXFD1:TAM of the maximum value MAXFD1 of the first facing distance between the cathode 10 and the aluminum metal 22 to the thickness TAM of the aluminum metal 22 may be, for example, greater than or equal to 1.1:1, greater than or equal to 1.5:1, greater than or equal to 2:1, greater than or equal to 3:1, or greater than or equal to 5:1. The ratio MAXFD1:TAM of the maximum value MAXFD1 of the first facing distance between the cathode 10 and the aluminum metal 22 to the thickness TAM of the aluminum metal 22 may be, for example, less than or equal to 100:1, less than or equal to 50:1, less than or equal to 30:1, or less than or equal to 10:1. When the ratio MAXFD1:TAM of the maximum value MAXFD1 of the first facing distance between the cathode 10 and the aluminum metal 22 to the thickness TAM of the aluminum metal 22 is within the disclosed range, preferential oxidation of the aluminum metal 22 in the first area A1 may be further prevented.

Referring to FIGS. 1 to 6, the aluminum metal 22 may have a length LAM of the aluminum metal 22 from the first end EAM1 to the second end EAM2. The aluminum metal 22 may have the thickness TAM of the aluminum metal 22 that is perpendicular to the length LAM of the aluminum metal 22. A ratio LAM:TAM of the length LAM of the aluminum metal 22 to the thickness TAM of the aluminum metal 22 may be, for example, greater than or equal to 10:1, greater than or equal to 30:1, greater than or equal to 50:1, or greater than or equal to 100:1. The ratio LAM: TAM of the length LAM of the aluminum metal 22 to the thickness TAM of the aluminum metal 22 may be less than or equal to 10,000:1 or less than or equal to 1,000:1. When the ratio LAM: TAM of the length LAM of the aluminum metal 22 to the thickness TAM of the aluminum metal 22 is within the disclosed range, a contact area between the aluminum metal 22 and the electrolyte 30 may increase, and a high discharge current density may be provided.

Referring to FIGS. 1 to 6, the length LAM of the aluminum metal 22 may be, for example, greater than or equal to 5 centimeters (cm), greater than or equal to 10 cm, greater than or equal to 50 cm, or greater than or equal to 100 cm. When the length LAM of the aluminum metal 22 is within the disclosed range, an increased energy density may be provided. The thickness TAM of the aluminum metal 22 may be, for example, greater than or equal to 10 micrometers (μm), greater than or equal to 100 μm, greater than or equal to 500 μm, greater than or equal to 1 mm, or greater than or equal to 10 mm. When the length LAM of the aluminum metal 22 is within the disclosed range, an increased energy density may be provided.

Referring to FIGS. 1 to 6, the facing distance FD between the cathode 10 and the aluminum metal 22 may be, for example, less than or equal to 10 cm, less than or equal to 5 cm, less than or equal to 2 cm, or less than or equal to 1 cm. When the facing distance FD between the cathode 10 and the aluminum metal 22 is within the disclosed range, an increased energy density may be provided. The facing distance FD between the cathode 10 and the aluminum metal 22 may have, for example, the maximum value of a facing distance between the cathode 10 and the aluminum metal 22.

Referring to FIGS. 1 to 3 and 6, the cathode 10 may have a first cathode thickness TCA1 in the first area A1 adjacent to the first end EAM1 of the aluminum metal 22. In the second area A2 adjacent to the second end EAM2 of the aluminum metal 22, the cathode 10 may have a second cathode thickness TCA2. The first cathode thickness TCA1 may be less than the second cathode thickness TCA2. When the first cathode thickness TCA1 is less than the second cathode thickness TCA2, preferential oxidation of the aluminum metal 22 in the first area A1 may be prevented.

A ratio TCA1:TCA2 of the first cathode thickness TCA1 to the second cathode thickness TCA2 may be, for example, less than or equal to 0.9:1, less than or equal to 0.7:1, or less than or equal to 0.5:1. The ratio TCA1:TCA2 of the first cathode thickness TCA1 to the second cathode thickness TCA2 may be, for example, in a range of about 0.1:1 to about 0.9:1, about 0.1:1 to about 0.7:1, or about 0.1:1 to about 0.5:1. When the ratio TCA1:TCA2 of the first cathode thickness TCA1 to the second cathode thickness TCA2 is within the disclosed a range, preferential oxidation of the aluminum metal 22 in the first area A1 may be prevented, and preferential oxidation of the aluminum metal 22 in the second area A2 may be induced.

Referring to FIG. 4, the cathode 10 may have the first cathode thickness TCA1 in the first area A1 adjacent to the first end EAM1 of the aluminum metal 22. In the second area A2 adjacent to the second end EAM2 of the aluminum metal 22, the cathode 10 may have the second cathode thickness TCA2. The first cathode thickness TCA1 may be greater than the second cathode thickness TCA2. The first cathode thickness TCA1 may be greater than the second cathode thickness TCA2, and the first facing distance FD1 between the cathode 10 and the aluminum metal 22 in the first area A1 may be greater than the second facing distance FD2 between the cathode 10 and the aluminum metal 22 in the second area A2. When the first facing distance FD1 is greater than the second facing distance FD2, preferential oxidation of the aluminum metal 22 in the first area A1 may be prevented.

The ratio TCA1:TCA2 of the first cathode thickness TCA1 to the second cathode thickness TCA2 may be, for example, greater than or equal to 1.1:1, greater than or equal to 1.5:1, or greater than or equal to 2:1. When the ratio TCA1:TCA2 of the first cathode thickness TCA1 to the second cathode thickness TCA2 is within the disclosed range, the cathode 10 having various shapes may be used.

Referring to FIG. 5, the cathode 10 may have the first cathode thickness TCA1 in the first area A1 adjacent to the first end EAM1 of the aluminum metal 22. In the second area A2 adjacent to the second end EAM2 of the aluminum metal 22, the cathode 10 may have the second cathode thickness TCA2. The first cathode thickness TCA1 may be equal to the second cathode thickness TCA2. The first cathode thickness TCA1 being equal to the second cathode thickness TCA2 means that the first cathode thickness TCA1 and the second cathode thickness TCA2 do not intentionally have different values. The first cathode thickness TCA1 being equal to the second cathode thickness TCA2 means that an unintended thickness difference therebetween may be, for example, less than or equal to 1%, less than or equal to 0.5%, or less than or equal to 0.1%. The cathode 10 may be prepared greater simply because the first cathode thickness TCA1 is equal to the second cathode thickness TCA2.

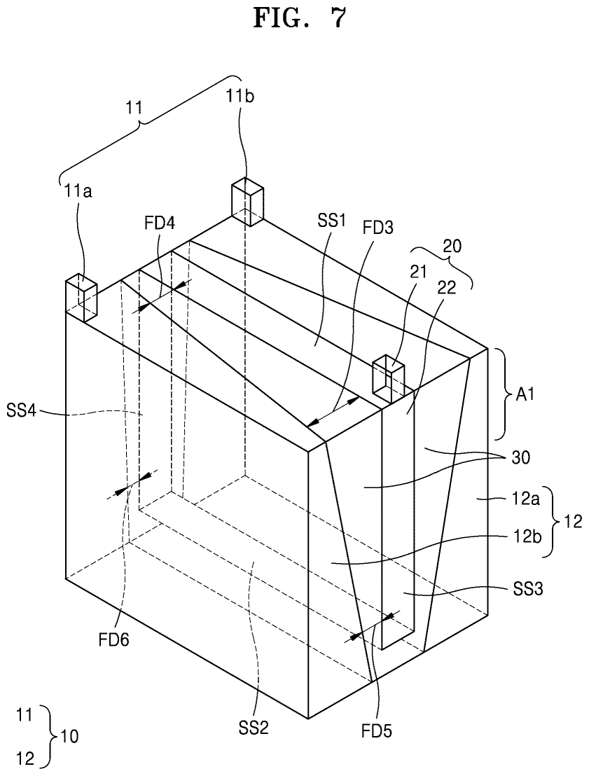

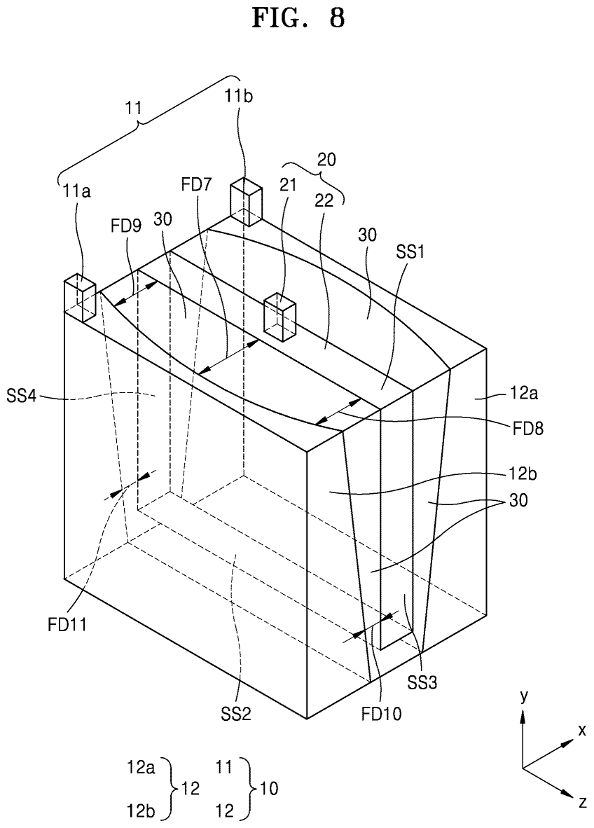

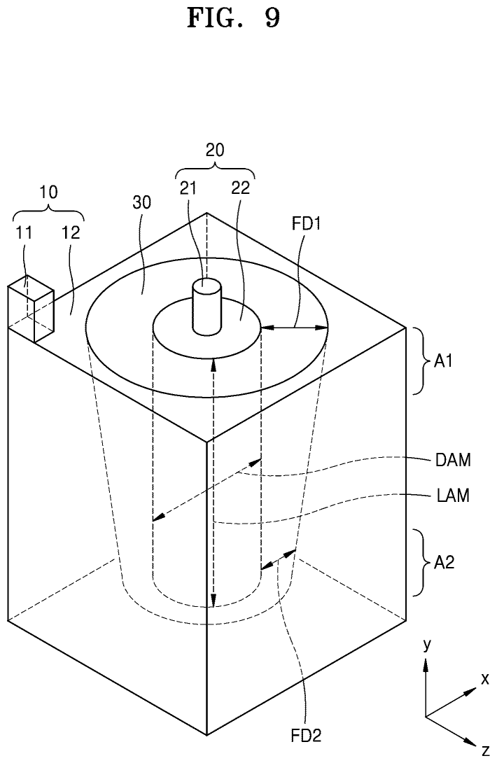

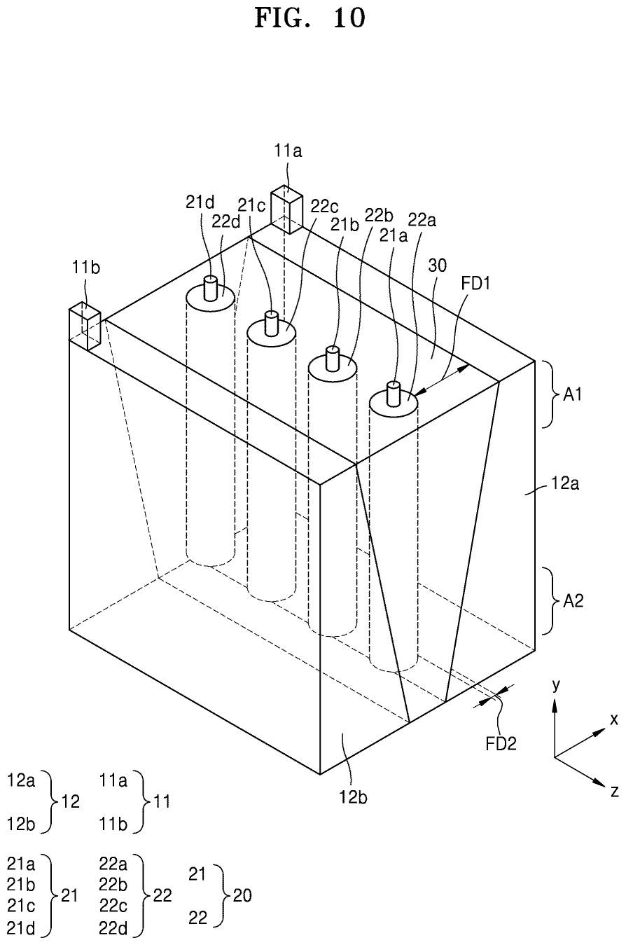

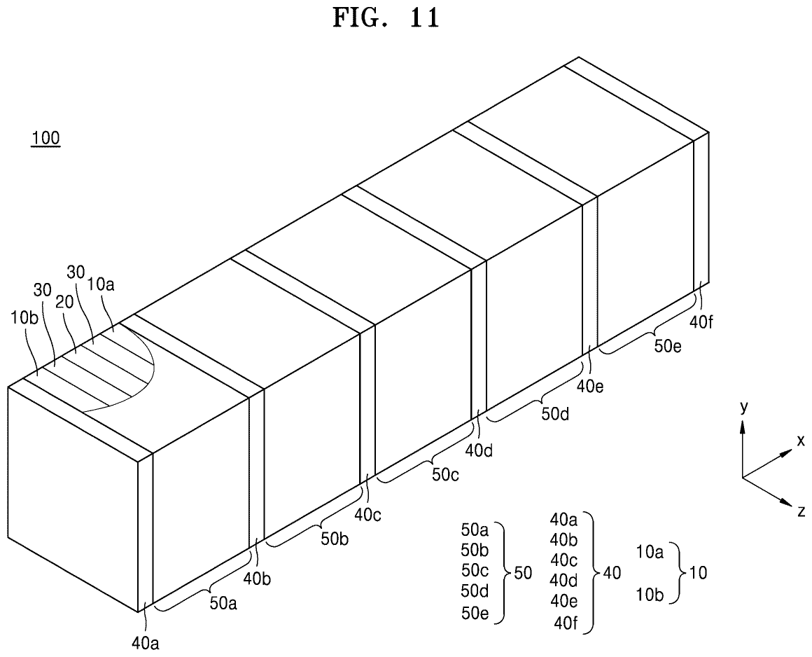

FIG. 7 is a perspective view of a metal-air battery 100 according to an embodiment. FIG. 8 is a perspective view of a metal-air battery 100 according to an embodiment. FIG. 9 is a perspective view of a metal-air battery 100 according to an embodiment. FIG. 10 is a perspective view of a metal-air battery 100 according to an embodiment. FIG. 11 is a perspective view of a metal-air battery 100 according to an embodiment.

Referring to FIGS. 1 to 4 and 6 to 11, a first side of the cathode 10 facing a first side of the aluminum metal 22 may have an inclination with respect to the first side of the aluminum metal 22 facing the first side of the cathode 10 of, e.g., may be angled relative to the first side of the aluminum metal 22 facing the first side of the cathode 10 at an angle of, for example, less than or equal to 45 degrees, less than or equal to 40 degrees, 3 less than or equal to 5 degrees, less than or equal to 30 degrees, less than or equal to 25 degrees, less than or equal to 20 degrees, less than or equal to 15 degrees, less than or equal to 10 degrees, or less than or equal to 5 degrees. The first side of the cathode 10 facing the first side of the aluminum metal 22 may have an inclination with respect to the first side of the aluminum metal 22 facing the first side of the cathode 10 of, e.g., may be angled relative to the first side of the aluminum metal 22 facing the first side of the cathode 10 at an angle of, for example, greater than 0, greater than or equal to 1 degree, greater than or equal to 2 degrees, greater than or equal to 3 degrees, or greater than or equal to 4 degrees.

The first side of the cathode 10 facing the first side of the aluminum metal 22 may have an inclination with respect to the first side of the aluminum metal 22 facing the first side of the cathode 10 of, e.g., may be angled relative to the first side of the aluminum metal 22 facing the first side of the cathode 10 at an angle of, for example, greater than about 0 to about 45 degrees, about 1 degree to about 40 degrees, about 1 degree to about 35 degrees, about 1 degree to about 30 degrees, about 1 degree to about 25 degrees, about 1 degree to about 20 degrees, about 1 degree to about 15 degrees, about 1 degree to about 10 degrees, or about 1 degree to about 5 degrees. When the first side of the cathode 10 facing the first side of the aluminum metal 22 has an inclination within the disclosed range with respect to the first side of the aluminum metal 22 facing the first side of the cathode 10, oxidation of the aluminum metal 22 may be preferentially induced in the second area A2.

Referring to FIG. 5, the aluminum metal 22 and the cathode 10 may mutually, e.g., each independently, have an inclination with respect to the y-axis of, for example, less than or equal to 45 degrees, less than or equal to 40 degrees, less than or equal to 35 degrees, less than or equal to 30 degrees, less than or equal to 25 degrees, less than or equal to 20 degrees, less than or equal to 15 degrees, less than or equal to 10 degrees, or less than or equal to 5 degrees. The aluminum metal 22 and the cathode 10 may mutually, e.g., each independently, have an inclination with respect to the y-axis of, for example, greater than 0, greater than or equal to 1 degree, greater than or equal to 2 degrees, greater than or equal to 3 degrees, or greater than or equal to 4 degrees. The aluminum metal 22 and the cathode 10 may mutually, e.g., each independently, have an inclination with respect to the y-axis of, for example, greater than about 0 degrees to about 45 degrees, about 1 degree to about 40 degrees, about 1 degree to about 35 degrees, about 1 degree to about 30 degrees, about 1 degree to about 25 degrees, about 1 degree to about 20 degrees, about 1 degree to about 15 degrees, about 1 degree to about 10 degrees, or about 1 degree to about 5 degrees. For example, the aluminum metal 22 may be disposed in a vertical direction (y direction), and the cathode 10 may have an inclination of greater than about 0 degrees to about 45 degrees, about 1 degree to about 40 degrees, about 1 degree to about 35 degrees, about 1 degree to about 30 degrees, about 1 degree to about 25 degrees, about 1 degree to about 20 degrees, about 1 degree to about 15 degrees, about 1 degree to about 10 degrees, or about 1 degree to about 5 degrees with respect to the vertical direction (y direction). When the aluminum metal 22 and the cathode 10 mutually, e.g., each independently, have an inclination with respect to the y-axis within the disclosed range, oxidation of the aluminum metal 22 may be preferentially induced in the second area A2. A thickness of the aluminum metal 22 may be equal to or different from a thickness of the cathode 10.

Referring to FIG. 6, the thickness of the aluminum metal 22 may decrease in the first direction (e.g., −y direction) in which the aluminum metal 22 extends, that is, according to a separation distance from the anode current collector 21. When the thickness of the aluminum metal 22 decreases in the first direction (e.g., −y direction) in which the aluminum metal 22 extends, the disconnection of the aluminum metal 22 due to, for example, oxidation in the first area A1 may be prevented.

In the first area A1 adjacent to the first end EAM1 of the aluminum metal 22, the aluminum metal 22 may have a first aluminum metal 22 thickness TAM1. In the second area A2 adjacent to the second end EAM2 of the aluminum metal 22, the aluminum metal 22 may have a second aluminum metal 22 thickness TAM2. The first aluminum metal 22 thickness TAM1 may be greater than the second aluminum metal 22 thickness TAM2. When the first aluminum metal 22 thickness TAM1 is greater than the second aluminum metal 22 thickness TAM2, the disconnection of the aluminum metal 22 due to, for example, oxidation in the first area A1 may be prevented.

A ratio TAM1:TAM2 of the first aluminum metal 22 thickness TAM1 to the second aluminum metal 22 thickness TMA2 may be, for example, greater than 1:1, greater than or equal to 1.5:1, or greater than or equal to 2:1. The ratio TAM1:TAM2 of the first aluminum metal 22 thickness TAM1 to the second aluminum metal 22 thickness TAM2 may be, for example, in a range of greater than about 1:1 to about 10:1, about 1.5:1 to about 10:1, or about 2:1 to about 10:1. When the ratio TAM1:TAM2 of the first aluminum metal 22 thickness TAM1 to the second aluminum metal 22 thickness TAM2 is within the disclosed range, the disconnection of the aluminum metal 22 due to, for example, oxidation in the first area A1 may be more effectively prevented. A ratio MAXTAM: MINFD2 of the maximum value MAXTAM of the thickness of the aluminum metal 22 to the minimum value MINFD2 of the second facing distance FD2 between the cathode 10 and the aluminum metal 22 may be, for example, greater than or equal to 1.1:1, greater than or equal to 1.5:1, or greater than or equal to 3:1. The ratio MAXTAM: MINFD2 of the maximum value MAXTAM of the thickness of the aluminum metal 22 to the minimum value MINFD2 of the second facing distance FD2 between the cathode 10 and the aluminum metal 22 may be in a range of about 1.1:1 to about 10:1, about 1.5:1 to about 10:1, or about 3:1 to about 10:1. When the ratio MAXTAM:MINFD2 of the maximum value MAXTAM of the thickness of the aluminum metal 22 to the minimum value MINFD2 of the second facing distance FD2 between the cathode 10 and the aluminum metal 22 is within the disclosed range, the disconnection of the aluminum metal 22 due to, for example, oxidation in the first area A1 may be more effectively prevented.

Referring to FIG. 7, the aluminum metal 22 may have a form of a sheet. The aluminum metal 22 having the form of a sheet may include a first side SS1 adjacent to the anode current collector 21, a second side SS2 opposite the first side SS1, a third side SS3 between, e.g., adjoining, the first side SS1 and the second side SS2, and a fourth side SS4 opposite the third side SS3. The anode current collector 21 may be disposed adjacent to an edge at an intersection of the first side SS1 and the third side SS3. A cathode current collector 11 may be disposed adjacent to, for example, an edge at an intersection of the first side SS1 and the fourth side SS4.

A third facing distance FD3 between the cathode 10 and the aluminum metal 22 in an area adjacent to the edge at the intersection of the first side SS1 and the third side SS3 may be greater than, for example, a fourth facing distance FD4 between the cathode 10 and the aluminum metal 22 in an area adjacent to the edge at an intersection of the first side SS1 and the fourth side SS3. The third facing distance FD3 between the cathode 10 and the aluminum metal 22 in the area adjacent to the edge at the intersection of the first side SS1 and the third side SS3 may be greater than, for example, a fifth facing distance FD5 between the cathode 10 and the aluminum metal 22 in an area adjacent to an edge at an intersection of the third side SS3 and the second side SS2. The third facing distance FD3 between the cathode 10 and the aluminum metal 22 in the area adjacent to the edge at the intersection of the first side SS1 and the third side SS3 may be greater than, for example, a sixth facing distance FD6 between the cathode 10 and the aluminum metal 22 in an area adjacent to an edge at an intersection of the fourth side SS4 and the second side SS2. For example, the fourth facing distance FD4 may be greater than the sixth facing distance FD6. For example, the fourth facing distance FD4 may be greater than the fifth facing distance FD5. When the metal-air battery 100 has such a structure, the disconnection of the aluminum metal 22 due to, for example, oxidation in the first area A1 adjacent to the anode current collector 21 may be more effectively prevented.

Referring to FIG. 8, the aluminum metal 22 may have a form of a sheet. The aluminum metal 22 having the form of a sheet may include a first side SS1 adjacent to the anode current collector 21, a second side SS2 opposite the first side SS1, a third side SS3 between, e.g., adjoining, the first side SS1 and the second side SS2, and a fourth side SS4 opposite the third side SS3. The anode current collector 21 may be disposed on the first side SS1 to be spaced apart from each of an edge at an intersection of the first side SS1 and the third side SS3 and an edge at an intersection of the first side SS1 and the fourth side SS4. Distances by which the anode current collector 21 is spaced from the edges may be, for example, the same.

A seventh facing distance FD7 between the cathode 10 and the aluminum metal 22 in an area adjacent to the anode current collector 21 may be greater than, for example, an eighth facing distance FD8 between the cathode 10 and the aluminum metal 22 in an area adjacent to the edge at the intersection of the first side SS1 and the third side SS3. The seventh facing distance FD7 between the cathode 10 and the aluminum metal 22 in the area adjacent to the anode current collector 21 may be greater than, for example, a ninth facing distance FD9 between the cathode 10 and the aluminum metal 22 in an area adjacent to the edge at the intersection of the first side SS1 and the fourth side SS4. The seventh facing distance FD7 between the cathode 10 and the aluminum metal 22 in the area adjacent to the anode current collector 21 may be greater than, for example, a tenth facing distance FD10 between the cathode 10 and the aluminum metal 22 in an area adjacent to an edge at an intersection of the second side SS2 and the third side SS3. The seventh facing distance FD7 between the cathode 10 and the aluminum metal 22 in the area adjacent to the anode current collector 21 may be greater than, for example, an eleventh facing distance FD11 between the cathode 10 and the aluminum metal 22 in an area adjacent to an edge at an intersection of the second side SS2 and the fourth side SS4. For example, the eighth facing distance FD8 may be greater than the tenth facing distance FD10. For example, the eighth facing distance FD8 may be greater than the eleventh facing distance FD11. For example, the ninth facing distance FD9 may be greater than the tenth facing distance FD10. For example, the ninth facing distance FD9 may be greater than the eleventh facing distance FD11. When the metal-air battery 100 has such a structure, the disconnection of the aluminum metal 22 due to, for example, oxidation in the first area A1 adjacent to the anode current collector 21 may be more effectively prevented.

Referring to FIGS. 1 to 8, the aluminum metal 22 may have the form of the sheet. The cathode 10 may include a first cathode 10a facing a first side of the anode 20, and a second cathode 10b facing second side of the anode 20 opposite the first side of the anode 20. When the first cathode 10a and the second cathode 10b are disposed on both, e.g., opposite or first and second, sides of the anode 20, respectively, local oxidation of the aluminum metal 22 may be prevented.

Referring to FIGS. 1 to 8, the first cathode 10a and the second cathode 10b may have symmetrical structures with respect to, e.g., relative to, the anode 20. When the first cathode 10a and the second cathode 10b have symmetrical structures with respect to, e.g., relative to, the anode 20, the structural stability of the metal-air battery 100 may be further improved.

Referring to FIGS. 9 and 10, the aluminum metal 22 may have, for example, a form of a rod or cylinder. When the aluminum metal 22 has, e.g., is in, a form of a rod or cylinder, the disconnection of the aluminum metal 22 may be more effectively prevented by local oxidation of the aluminum metal 22. For example, the cathode 10 may surround a circumferential side of the aluminum metal 22 having the form of a rod or cylinder. For example, the cathode 10 may surround a portion or all of a circumferential side of the aluminum metal 22 having the form of a rod or cylinder. When the cathode 10 surrounds the circumferential side of the aluminum metal 22 having the form of a rod or cylinder, the disconnection of the aluminum metal 22 due to, for example, local oxidation of the aluminum metal 22 may be more effectively prevented. A cross section of the aluminum metal 22 having the form of a rod or cylinder may have, for example, a circular, oval, or polygonal shape. The polygonal shape may be, for example, a triangular shape, a quadrangular shape, a pentagonal shape, or the like.

Referring to FIGS. 9 and 10, the aluminum metal 22 having the form of a rod or cylinder may have a length LAM from the first end EAM1 to the second end EAM2 and a diameter DAM perpendicular to the length LAM. A ratio LAM:DAM of the length LAM to the diameter DAM may be, for example, greater than 1:1, greater than or equal to 2:1, greater than or equal to 5:1, or greater than or equal to 10:1. The ratio LAM:DAM of the length LAM to the diameter DAM may be, for example, in a range of greater than about 1:1 to about 1,0000:1, about 2:1 to about 500:1, about 5:1 to about 100:1, or about 10:1 to about 100:1. When the ratio LAM:DAM of the length LAM to the diameter DAM is within the disclosed range, a contact area between the aluminum metal 22 and the electrolyte 30 may increase, and a high discharge current density may be provided.

Referring to FIGS. 9 and 10, a facing distance FD1 between the cathode 10 and the aluminum metal 22 in the first area A1 adjacent to the anode current collector 21 may be less than the diameter DAM of the aluminum metal 22. In the first area A1 adjacent to the anode current collector 21, a ratio FD1:DAM of the facing distance FD1 between the cathode 10 and the aluminum metal 22 to the diameter DAM of the aluminum metal 22 may be, for example, less than 1:1, less than or equal to 0.9:1, less than or equal to 0.8:1, or less than or equal to 0.5:1. When the ratio FD1:DAM of the facing distance FD1 between the cathode 10 and the aluminum metal 22 to the diameter DAM of the aluminum metal 22 in the first area A1 adjacent to the anode current collector 21 is within the disclosed range, the energy density of the metal-air battery 100 may be improved.

Referring to FIG. 10, the anode 20 may include a plurality of aluminum metals 22a, 22b, 22c, and 22d each having a form of a rod or cylinder and disposed adjacent to a plurality of anode current collectors 21a, 21b, 21c, and 21d, respectively. The plurality of aluminum metals 22a, 22b, 22c, and 22d having the form of a rod or cylinder may be disposed to be spaced apart from each other in a width direction (z direction) of the metal-air battery 100. The plurality of anode current collectors 21a, 21b, 21c, and 21d may be electrically connected to the plurality of aluminum metals 22a, 22b, 22c, and 22d having the form of a rod or cylinder, respectively. Although not shown in the drawing, the plurality of anode current collectors 21a, 21b, 21c, and 21d may be electrically connected to each other. When the plurality of aluminum metals 22a, 22b, 22c, and 22d having the form of a rod or cylinder are disposed to be spaced apart from each other in the width direction (z direction) of the metal-air battery 100, a contact area between the aluminum metal 22 (22a, 22b, 22c, or 22d) and the electrolyte 30 may increase, and the current density of the metal-air battery 100 may be improved.

Referring to FIGS. 1 to 10, the cathode 10 may include the cathode current collector 11 and a cathode active material layer 12. The cathode 10 may include the first cathode 10a and the second cathode 10b. The first cathode 10a may include a first cathode current collector 11a and a first cathode active material layer 12a. The second cathode 10b may include a second cathode current collector 11b and a second cathode active material layer 12b.

The cathode active material layer 12 may include a porous material. The porous material may be a conductive material. As the porous material, any suitable conductive material may be used. The porous material may be, for example, a carbon-based material (i.e., a carbon-containing material). As the carbon-based material, for example, carbon black, graphite, graphene, activated carbon, carbon fiber, or the like may be used. The carbon-based material may include, for example, carbon nanoparticles, carbon nanotubes, carbon nanofibers, carbon nanosheets, carbon nanorods, carbon nanobelts, or a combination thereof. As the carbon-based material, for example, nanostructures, microstructures, or a combination thereof may be used. For example, the carbon-based material may include microstructures having various forms with a microsize, such as particles, tubes, fibers, sheets, rods, belts, or a combination thereof.

The carbon-based material may be, for example, a mesoporous carbon-based material. The carbon-based material may have porosity in some or all areas of the material. When the cathode active material layer 12 includes a porous carbon-based material, porosity may be introduced into the cathode 10, and a porous cathode 10 may be formed. When the carbon-based material is porous, e.g., has porosity, a contact area with the electrolyte 30 may increase. The supply and diffusion of oxygen in the cathode 10 may become easier, and a space in which products generated during a discharging process are dissolved may be provided.

As a conductive porous material, for example, metal fiber, a metal mesh, or the like may be used. A metallic powder such as copper, silver, nickel, or aluminum may be used as a conductive material. An organic conductive material such as a polyphenylene derivative may also be used as the conductive material. The disclosed conductive materials may be used alone or in mixture.

The cathode active material layer 12 may further include for example, a binder, a catalyst, a water-repellent treatment agent, or a combination thereof.

The cathode active material layer 12 may further include a binder. The binder may include, for example, a thermoplastic resin or a thermosetting resin. As the binder, for example, polyethylene, polypropylene, polytetrafluoroethylene (PTFE), polyvinylidene fluoride (PVDF), styrene-butadiene rubber, a tetrafluoroethylene-perfluoroalkyl vinyl ether copolymer, a vinylidene fluoride-hexafluoro propylene copolymer, a vinylidene fluoride-chlorotrifluoroethylene copolymer, an ethylene-tetrafluoroethylene copolymer, polychlorotrifluoroethylene, a vinylidene fluoride-pentafluoro propylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethyl vinyl ether-tetrafluoro ethylene copolymer, an ethylene-acrylic acid copolymer, or a combination thereof. Any suitable material may be used, provided the material may be used as a binder.

The cathode active material layer 12 may further include a catalyst for oxidation/reduction of oxygen. Examples of such a catalyst may include a noble metal-based (i.e., noble metal-containing) catalyst such as a platinum, gold, silver, palladium, ruthenium, rhodium, or osmium catalyst; an oxide-based (i.e., oxide-containing) catalyst such as a manganese oxide, iron oxide, cobalt oxide, or nickel oxide catalyst; or an organometal-based (i.e., organometal-containing) catalyst such as a cobalt phthalocyanine catalyst; or a combination thereof.

The disclosed catalyst may be supported on, for example, a carrier. The carrier may be, for example, an oxide, a zeolite, a clay mineral, carbon, or the like. The oxide may include alumina, silica, zirconium oxide, titanium dioxide, or a combination thereof. For example, the oxide may be an oxide including Ce, Pr, Sm, Eu, Tb, Tm, Yb, Sb, Bi, V, Cr, Mn, Fe, Co, Ni, Cu, Nb, Mo, W, or a combination thereof. Carbon may be, for example, carbon black such as Ketjen black, acetylene black, channel black, or lamp black, graphite such as natural graphite, artificial graphite, or expanded graphite, activated carbon, carbon fiber, or the like.

The cathode active material layer 12 may further include a water-repellent treatment agent. When the cathode active material layer 12 includes the water-repellent treatment agent, flooding of the electrolyte 30 in the cathode active material layer 12 may be prevented. When the electrolyte 30 is flooded in the cathode active material layer 12, an oxygen supply path may be blocked. A water-repellent treatment agent is not particularly limited, provided the water-repellent treatment agent has a water-repellent ability. For example, the water-repellent treatment agent may be a fluorine-based (i.e., fluorine-containing) binder. The water-repellent treatment agent may be, for example, PTFE.

For example, after the disclosed porous material, oxygen oxidation/reduction catalyst, binder, and water-repellent treatment agent are mixed, an appropriate solvent may be added to prepare a cathode slurry, and then the cathode slurry may be applied onto a surface of the cathode current collector 11 and dried or may be optionally pressed and molded on a current collector to improve an electrode density, and the cathode active material layer 12 may be prepared. As described herein, a process of irradiating light after coating and drying may be further performed.

As the cathode current collector 11, a porous body such as a mesh or mesh-shaped body may be used to rapidly diffuse oxygen. As the cathode current collector 11, a porous metal plate comprising or consisting of stainless steel, nickel, or aluminum may be used. Any suitable material may be used provided the material may be used as a current collector. The cathode current collector 11 may be coated with an oxidation-resistant metal or alloy film to prevent oxidation.

Referring to FIGS. 1 to 10, the anode 20 may include the anode current collector 21. The anode current collector 21 may include, for example, copper (Cu), stainless steel, titanium (Ti), iron (Fe), cobalt (Co), nickel (Ni), indium (In), or the like. Any suitable material may be used, provided the material may be used as an electrode current collector. The anode current collector 21 may consist of one type of the disclosed metals or an alloy or coating material of two or more types of metals. The anode current collector 21 may be, for example, in the form of a plate or foil.

Referring to FIGS. 1 to 10, the electrolyte 30 may include an alkali metal salt and a solvent. The alkali metal salt may be, for example, KOH, NaOH, or LiOH. The solvent may be, for example, distilled water. A concentration of the alkali metal salt may be, for example, in a range of about 0.1 Molar (M; moles per liter) to about 10 M.

Electrode reactions of an aluminum-air battery may be as follows:
Cathode oxidation reaction: Al+4OH⁻→Al(OH)₄⁻+3e⁻(−2.38 V_{SHE})
Anode reduction reaction: O₂+2H₂O+4e⁻→4OH⁻(0.4 V_{SHE})
Overall cell reaction: 4Al+3O₂+6H₂O→4Al(OH)₃

In an aluminum-air battery, electrons generated during an ionization process of the aluminum metal 22, which is included in the anode 20, move to an air electrode, which is the cathode 10, along a conducting wire to reduce oxygen and water in the air to generate electricity.

Referring to FIG. 11, the metal-air battery 100 may further include a gas diffusion layers 40 (40a, 40b, 40c, 40d, 40e, and 40f) disposed on a second side of the cathode 10 opposite the first side of the cathode 10. When the metal-air battery 100 further includes the gas diffusion layers 40 (40a, 40b, 40c, 40d, 40e, and 40f) disposed on the second side of the cathode 10, oxygen may be easily supplied to the cathode 10. The metal-air battery 100 may include, for example, a plurality of unit cells 50 (50a, 50b, 50c, 50d, and 50e), and the unit cells 50 (50a, 50b, 50c, 50d, and 50e may each include the anode 20 and the first and second cathodes 10a disposed on both, e.g., opposite or first and second, sides of the anode 20. The gas diffusion layers 40 (40a, 40b, 40c, 40d, 40e, and 40f) may be disposed on one or more sides of the first cathodes 10a and the second cathodes 10b of the unit cells 50 (50a, 50b, 50c, 50d, and 50e). The gas diffusion layers 40 (40a, 40b, 40c, 40d, 40e, and 40f) may be disposed between the unit cells 50 (50a, 50b, 50c, 50d, and 50e) that are disposed adjacent to each other. Gas including oxygen, for example, air, may be supplied through the gas diffusion layer 40 (40a, 40b, 40c, 40d, 40e, or 40f). The gas diffusion layer 40 (40a, 40b, 40c, 40d, 40e, or 40f) may be, for example, a porous conductive substrate. The gas diffusion layers 40 (40a, 40b, 40c, 40d, 40e, and 40f) may simultaneously serve as the cathode current collector 11. The gas diffusion layer 40 (40a, 40b, 40c, 40d, 40e, or 40f) may consist of, for example, porous carbon paper, porous metal mesh, or the like.

### Power Supply

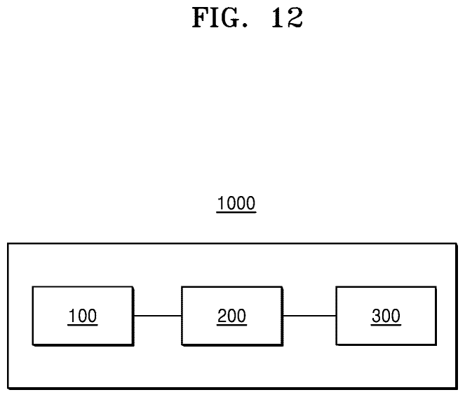

FIG. 12 is a block diagram of a power supply according to an embodiment.

A power supply 1000 according to an embodiment of the present invention may include the metal-air battery 100 described herein, an inverter 200 that converts direct current (DC) power output from the metal-air battery 100 into alternating current (AC) power, and an output unit 300 that outputs the AC power converted by the inverter 200 to a load. When the power supply 1000 includes the metal-air battery 100 described herein, electrical energy with a constant current density or voltage may be stably supplied without a sudden decrease in discharge capacity.

For the metal-air battery 100, reference may be made to the disclosed content. The inverter 200 may convert DC power output from the metal-air battery 100 into AC power. The inverter 200 may convert DC power into AC power and then may apply the AC power to the output unit 300. A first switch (not shown) may be disposed between the metal-air battery 100 and the inverter 200. The first switch (not shown) may be adjusted by a controller (not shown). For example, when power supply from the power supply 1000 is not required, the controller (not shown) may block the first switch (not shown). When power supply from the power supply 1000 is required, the controller (not shown) may connect the first switch (not shown) to convert DC power output from the metal-air battery 100 into AC power. A second switch (not shown) may be disposed between the inverter 200 and the output unit 300. The second switch (not shown) may be adjusted by a controller (not shown). For example, when power supply from the power supply 1000 is not required, the controller (not shown) may block the second switch (not shown). When power supply from the power supply 1000 is required, the controller (not shown) may connect the second switch (not shown) to apply AC power output from the inverter 200 to the output unit 300. The output unit 300 may output AC power to the load. The power supply 1000 may be used, for example, as an emergency power supply 1000. The power supply 1000 including the metal-air battery 100 may not include a separate cathode active material and may provide an improved energy density.

### Method of Manufacturing Metal-Air Battery

A method of manufacturing a metal-air battery 100 according to an embodiment may include providing a cathode 10 configured to use oxygen as an active material, providing an anode 20 including an anode current collector 21 and an aluminum metal 22 extending from the first end EAM1 adjacent to the anode current collector 21 to the second end EAM2 opposite the first end EAM1, and providing an electrolyte 30 between the cathode 10 and the anode 20. A facing distance between the cathode 10 and the aluminum metal 22 may decrease in a direction in which the aluminum metal 22 extends. When the facing distance between the cathode 10 and the aluminum metal 22 decreases in the direction in which the aluminum metal 22 extends, a decrease in energy density due to, for example, the disconnection of the aluminum metal 22 during discharge of the metal-air battery 100 may be prevented.

The cathode 10 configured to use oxygen as an active material may be provided. For example, after a porous material, an oxygen oxidation/reduction catalyst, a binder, and a water-repellent treatment agent are mixed, an appropriate solvent may be added to prepare a cathode slurry, then the cathode slurry may be applied onto a surface of a cathode current collector 11 and dried or may be optionally pressed and molded on a current collector to improve an electrode density, and the cathode 10 may be prepared. For specific details of the porous material, the catalyst, the binder, and the water-repellent treatment agent, reference may be made to the metal-air battery 100 described herein.

The anode 20 may be provided. The anode 20 may include the anode current collector 21, and the aluminum metal 22 extending from the first end EAM1 adjacent to the anode current collector 21 to the second end EAM2 opposite the first end EAM1. For example, the anode 20 may have a structure in which the anode current collector 21 is connected to a first side of an aluminum metal 22 sheet. A first cathode 10a and a second cathode 10b may be disposed on both, e.g., opposite or first and second, sides of the anode 20 to be spaced apart from each other. For example, the first cathode 10a and the second cathode 10b may be connected to each other to constitute a portion of a container that accommodates the electrolyte 30.

An alkali metal salt may be dissolved in distilled water to prepare the electrolyte 30 in the form of an aqueous solution. The electrolyte 30 may be injected between the cathode 10 and the anode 20.

The cathode 10 and the anode 20 may be disposed such that the facing distance between the cathode 10 and the aluminum metal 22 decreases in the direction in which the aluminum metal 22 extends. For example, the cathode 10 may be disposed to have an inclination of less than or equal to 45 degrees with respect to the anode 20, and the facing distance between the cathode 10 and the anode 20 in an area adjacent to the anode current collector 21 may have a larger value than the facing distance between the cathode 10 and the anode 20 in an area that is furthest from the anode current collector 21. Such a configuration may be determined by an angle between the cathode 10 and the anode 20 or the shape of the cathode 10 and/or anode 20.

Hereinafter, the disclosure will be described in detail through the following Examples and Comparative Examples. However, the scope of the disclosure is not limited thereto.

### Evaluation Example 1: Calculation of Thickness Change of Aluminum Anode

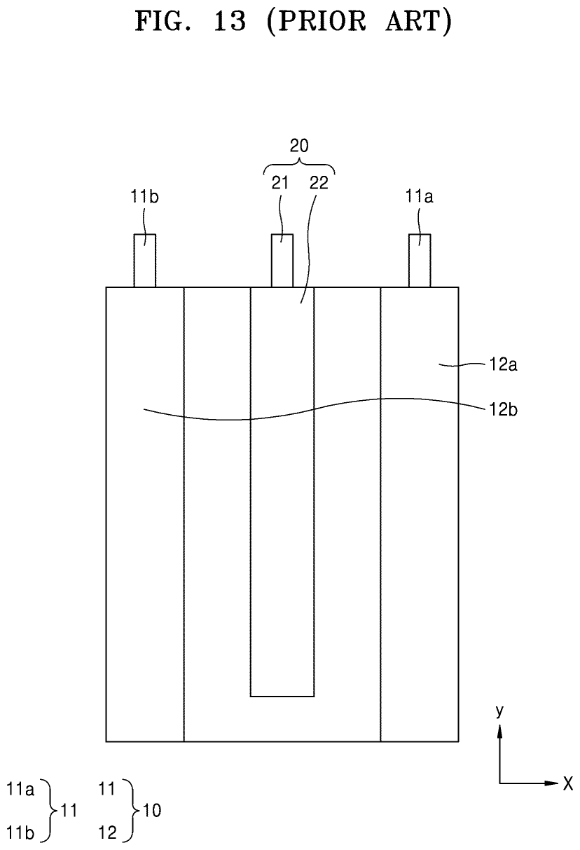

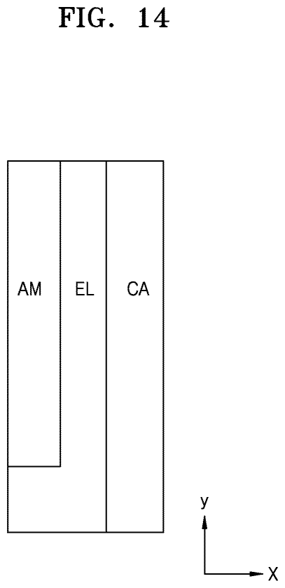

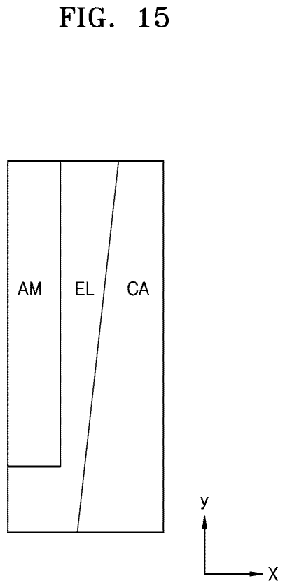

In order to evaluate a thickness change of an aluminum anode according to a distance from a current collector during discharge of an aluminum-air battery, an aluminum-metal battery of Comparative Example 1 having a structure of FIG. 14 was modeled based on a unit structure at the right side of FIG. 13, an aluminum-metal battery of Example 1 having a structure of FIG. 15 was modeled based on a unit structure at the right side of FIG. 1, and calculations were performed using COMSOL Multiphysics® software, respectively.

A unit structure of FIG. 14 is modeled on the right half of the aluminum-air battery having the structure of FIG. 13. CA denotes a cathode, EL denotes an electrolyte, and AM denotes an aluminum metal.

A unit structure of FIG. 15 is modeled on the right half of the aluminum-air battery having the structure of FIG. 1. CA denotes a cathode, EL denotes an electrolyte, and AM denotes an aluminum metal.

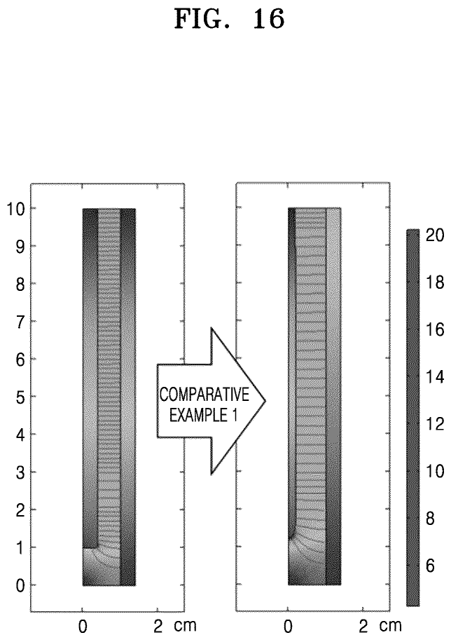

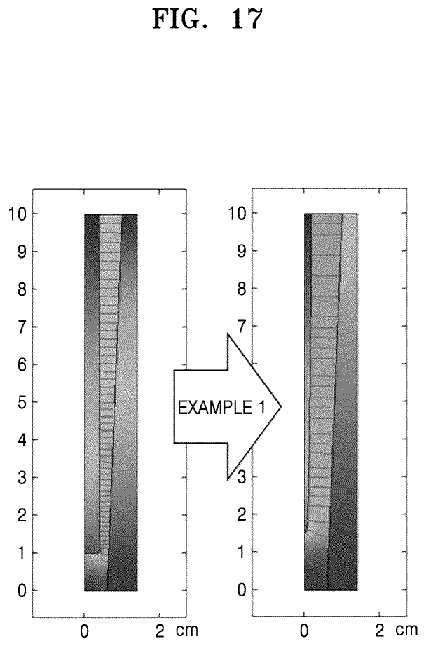

Calculation results for the aluminum-metal batteries of Comparative Example 1 and Example 1 are shown in FIGS. 16 and 17, respectively.

A left image in FIG. 16 shows the shape and current density distribution of an aluminum-metal anode at an initial stage of discharging of the aluminum-metal battery of Comparative Example 1. It was shown that a facing distance between the aluminum metal anode and the cathode at the initial stage of discharging was constant irrespective of a distance from an anode current collector (not shown) connected to an upper end of the aluminum metal.

A right image in FIG. 16 shows the shape and current density distribution of the aluminum-metal anode at a final stage of discharging of the aluminum-metal battery of Comparative Example 1. At the final stage of discharging, the overall thickness of the aluminum metal anode decreased. It was shown that, at the final stage of discharging, a thickness of the aluminum metal anode in an area adjacent to the upper end of the aluminum metal connected to a current collector (not shown) was less than a thickness of the aluminum metal cathode in an area adjacent to a lower end that was furthest from the current collector (not shown).

A left image in FIG. 17 shows the shape and current density distribution of an aluminum-metal anode at an initial stage of discharging of the aluminum-metal battery of Example 1. It was shown that a facing distance between the aluminum metal cathode and the cathode at the initial stage of discharging was increased as a distance from an anode current collector (not shown) connected to an upper end of the aluminum metal was increased.

The right side In FIG. 17 shows the shape and current density distribution of the aluminum-metal anode at a final stage of discharging of the aluminum-metal battery of Example 1. At the final stage of discharging, the overall thickness of the aluminum metal anode decreased. It was shown that, at the final stage of discharging, a thickness of the aluminum metal anode at the upper end adjacent to a current collector (not shown) was less than a thickness of the aluminum metal cathode at a lower end that was furthest from the current collector (not shown).

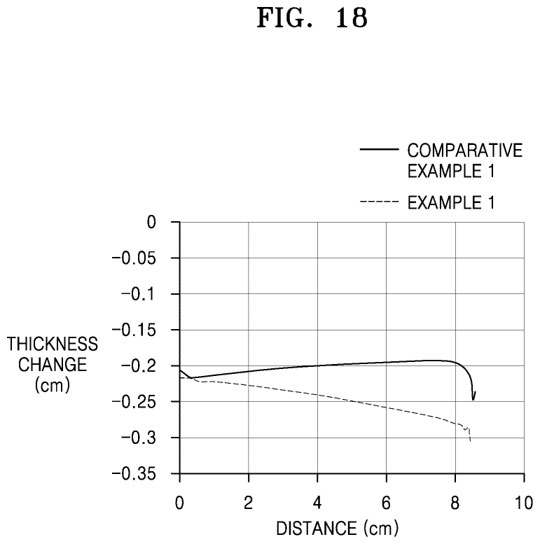

FIG. 18 is a graph showing the thickness of the aluminum metal anode according to the distance from the current collector at the final state of discharging of the aluminum metal anode of each of FIGS. 16 and 17.

As shown in FIG. 18, in the aluminum-metal battery of Example 1, it was shown that, as the distance from the anode current collector was increased after discharging was performed, the thickness of the aluminum metal anode was decreased, and stable discharge was possible without the disconnection of the aluminum metal anode.

In the aluminum-metal battery of Comparative Example 1, it was shown that, as the distance from the anode current collector was decreased after discharging was performed, the thickness of the aluminum metal anode was decreased, and the possibility of the disconnection of the aluminum metal anode was increased.

Although embodiments have been described above, one or more embodiments are not limited thereto, and may be embodied by being modified in various ways within the scope of the claims, the detailed description, and the accompanying drawings. It is apparent that such modifications fall within the scope of the disclosure.

According to an embodiment, there may be provided a novel metal-air battery which has a novel structure, and disconnection of a metal anode during discharge of the metal-air battery may be prevented.

According to an embodiment, there may be provided a power supply which includes a novel metal-air battery to provide improved stability.

According to an embodiment, there may be provided a method of manufacturing a novel metal-air battery.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the FIGS., it will be understood by those of ordinary skill in the art that various changes in form and details may be made therein without departing from the spirit and scope as defined by the following claims.

What is claimed is:

1. A metal-air battery comprising:
a cathode configured to use oxygen as an active material;
an anode comprising an anode current collector and an aluminum metal extending in a first direction from a first end adjacent to the anode current collector to a second end opposite the first end; and
an electrolyte between the cathode and the anode,
wherein a distance between the cathode and the aluminum metal decreases in the first direction.

2. The metal-air battery of claim 1, wherein the distance between the cathode and the aluminum metal decreases continuously or stepwise in the first direction.

3. The metal-air battery of claim 1, wherein
a first distance between the cathode and the aluminum metal in a first area adjacent to the first end of the aluminum metal is greater than a second distance between the cathode and the aluminum metal in a first area adjacent to the second end of the aluminum metal.

4. The metal-air battery of claim 3, wherein a ratio of the first distance to the second distance is more than 1:1 and less than or equal to 100:1.

5. The metal-air battery of claim 3, wherein
a minimum value of the second distance between the cathode and the aluminum metal is less than a thickness of the aluminum metal, and
a ratio of the minimum value of the second distance between the cathode and the aluminum metal to the thickness of the aluminum metal is less than or equal to 0.9:1.

6. The metal-air battery of claim 3, wherein
a maximum value of the first distance between the cathode and the aluminum metal is greater than a thickness of the aluminum metal, and
a ratio of the maximum value of the first distance between the cathode and the aluminum metal to the thickness of the aluminum metal is greater than or equal to 1.1:1.

7. The metal-air battery of claim 1, wherein
the aluminum metal has a length from the first end to the second end and a thickness perpendicular to the length, and
a ratio of the length from the first end to the second end to the thickness perpendicular to the length is greater than or equal to 10:1.

8. The metal-air battery of claim 1, wherein
a length of the aluminum metal is greater than or equal to 10 centimeters,
a thickness of the aluminum metal is greater than or equal to 100 micrometers, and
the distance between the cathode and the aluminum metal is less than or equal to 10 centimeters.

9. The metal-air battery of claim 1, wherein
the cathode has a first cathode thickness in a first area adjacent to the first end of the aluminum metal,
the cathode has a second cathode thickness in a second area adjacent to the second end of the aluminum metal, and
the first cathode thickness is less than the second cathode thickness.

10. The metal-air battery of claim 9, wherein a ratio of the first cathode thickness to the second cathode thickness is less than or equal to 0.9:1.

11. The metal-air battery of claim 1, wherein
the cathode has a first cathode thickness in a first area adjacent to the first end of the aluminum metal,
the cathode has a second cathode thickness in a second area adjacent to the second end of the aluminum metal, and
the first cathode thickness is greater than the second cathode thickness.

12. The metal-air battery of claim 1, wherein a first side of the cathode facing the aluminum metal has an inclination of less than or equal to 45 degrees with respect to a first side of the aluminum metal facing the cathode.

13. The metal-air battery of claim 1, wherein
the aluminum metal has a form of a sheet,
the sheet has a first side adjacent to the anode current collector, a second side opposite the first side, a third side adjoining the first side and the second side, and a fourth side opposite the third side, and
the anode current collector is disposed adjacent to an edge at an intersection of the first side and the third side.

14. The metal-air battery of claim 1, wherein
the aluminum metal has a form of a sheet,
the sheet has a first side adjacent to the anode current collector, a second side opposite the first side, a third side adjoining the first side and the second side, and a fourth side opposite the third side, and
the anode current collector is disposed on the first side and spaced apart from each of an edge at an intersection of the first side and the third side and an edge at an intersection of the first side and the fourth side.

15. The metal-air battery of claim 1, wherein
the aluminum metal has a form of a sheet, and
the cathode comprises:
a first cathode facing a first side of the anode; and
a second anode facing a second side of the anode opposite the first side of the anode.

16. The metal-air battery of claim 15, wherein the first cathode and the second cathode have symmetrical structures with respect to the anode.

17. The metal-air battery of claim 1, wherein
the aluminum metal has a form of a cylinder, and
the cathode surrounds a circumferential side of the cylinder.

18. The metal-air battery of claim 1, further comprising a gas diffusion layer disposed on a second side of the cathode opposite the first side of the cathode.

19. A power supply comprising:
the metal-air battery of claim 1;
an inverter configured to convert direct current power output from the metal-air battery into alternating current power; and
an output unit configured to output, to a load, the alternating current power converted by the inverter to a load.

20. A method of manufacturing a metal-air battery, the method comprising:
providing a cathode configured to use oxygen as an active material;
providing an anode comprising an anode current collector and an aluminum metal extending in a first direction from a first end adjacent to the anode current collector to a second end opposite the first end; and
providing an electrolyte between the cathode and the anode,
wherein a distance between the cathode and the aluminum metal decreases in the first direction.
